(19) United States
(12) Patent Application Publication
(10) Pub. No.: US 2021/0088850 A1
(43) Pub. Date: Mar. 25, 2021

(54) LIGHT EMITTING DIODE DEVICE AND BACKLIGHT MODULE AND DISPLAY DEVICE COMPRISING THE SAME

(71) Applicants: Chung-Hwa LEE, New Taipei City (TW); Jian-Ging CHEN, Kaohsiung City (TW)

(72) Inventors: Chung-Hwa LEE, New Taipei City (TW); Jian-Ging CHEN, Kaohsiung City (TW)

(21) Appl. No.: 17/016,430

(22) Filed: Sep. 10, 2020

(30) Foreign Application Priority Data
Sep. 19, 2019 (TW) 108133712

(51) Int. Cl. G02F 1/13357

(52) U.S. Cl. CPC G02F 1/133606; G02F 2001/133607; G02F 1/133605; G02F 1/133603

(57) ABSTRACT

A light emitting diode device includes: a diffusing lens including a diffusing body, wherein the diffusing body has a cavity and a light emitting surface; a light emitting diode disposed in the cavity; and a light absorbing material disposed on a light path that light emitting from the light emitting diode passes through the diffusing body and emits from the light emitting surface, wherein the light absorbing material is a yellow light absorbing material. In addition, a backlight module and a display device using the aforesaid light emitting diode device are also disclosed.

### CROSS REFERENCE TO RELATED APPLICATION

This application claims the benefits of the Taiwan Patent Application Serial Number 108133712, filed on Sep. 19, 2019, the subject matter of which is incorporated herein by reference.

### BACKGROUND

### 1. Field

The present disclosure relates to a light emitting diode (LED) device and a backlight module and a display device comprising the same. More specifically, the present disclosure relates to an LED device with improved color gamut and a backlight module and a display device comprising the same.

### 2. Description of Related Art

White LEDs can be applied to various fields, for example, can be used to a light source or a backlight module of a display device. It is known that the material for a light emitting layer of the white LED may be phosphors or quantum dots. Compared to the light emitting from the quantum dots, the light emitting from the phosphors have more unwanted light. Thus, the color gamut of the white LED prepared with the phosphors is not as ideal as the white LED prepared with the quantum dots. Therefore, some manufactures currently use quantum dots as the material for the light emitting layer to prepare the white LEDs to improve the backlight effect of the backlight module of the display device when the white LEDs are applied thereto.

However, the manufacture cost using the quantum dots is high. If the unwanted light emitting from the phosphors can be effectively removed to improve the color gamut of the white LEDs, the backlight effect of the backlight module of the display device can also be effectively improved even though the quantum dots are not used as the material for the light emitting layer of the white LEDs.

Therefore, it is desirable to provide a novel white LED device using phosphors to be effectively applied to the backlight module of the display device.

### SUMMARY

The present disclosure provides a light emitting diode (LED) device, wherein a yellow light absorbing material is used to improve the color gamut of the LED device.

The LED device of the present disclosure comprises: a diffusing lens comprising a diffusing body, wherein the diffusing body has a cavity and a light emitting surface; a light emitting diode (LED) disposed in the cavity; and a light absorbing material disposed on a light path that light emitting from the light emitting diode passes through the diffusing body and emits from the light emitting surface, wherein the light absorbing material is a yellow light absorbing material.

In the LED device of the present disclosure, the yellow light absorbing material is used to absorb the unwanted light (stray light) in the yellow wavelength range to reduce the intensity of the unwanted light in the yellow wavelength range, and thus the color gamut of the LED device can be improved. Hence, when the LED device of the present disclosure is applied to a backlight module of a display device, backlight with wide color gamut can be provided, and therefore the display quality of the display device can be enhanced.

In the LED device of the present disclosure, the LED can be a white light LED.

In the LED device of the present disclosure, the yellow light absorbing material is a material capable of absorbing light with wavelengths ranged from 550 nm to 610 nm. The type of the yellow light absorbing material is not particularly limited, as long as it has the property of absorbing the light with the aforesaid wavelength range. The yellow light absorbing material can be an organic dye or an inorganic pigment. Examples of the yellow light absorbing material include, but are not limited to, a triphenylmethane-based material, cobalt blue, cobalt violet or a combination thereof.

In the LED device of the present disclosure, the diffusing body of the diffusing lens may comprise a lens material. Herein, the lens material is not particularly limited, as long as it is a lens material with high transmittance. For example, the lens material may comprise, but is not limited to, polyvinyl chloride (PVC), polycarbonate (PC), poly(methyl methacrylate) (PMMA) or a combination thereof.

In one aspect of the present disclosure, the diffusing body may comprise the lens material and the light absorbing material. In other words, the diffusing body is formed by a combination of the lens material and the light absorbing material. Hence, when the light emitting from the light emitting diode penetrates through the diffusing body and emits from the light emitting surface, the light absorbing material included in the diffusing body can absorb the unwanted light in the yellow wavelength range. Herein, the feature of the lens material is described above and not repeated again.

In another aspect of the present disclosure, the light absorbing material may be disposed on the light emitting surface of the diffusing body. In other words, the light absorbing material can be formed into a thin film on the light emitting surface of the diffusing body. Hence, when the light emitting from the light emitting diode penetrates through the diffusing body and emits from the light emitting surface, the unwanted light in the yellow wavelength range which achieves the light emitting surface can be absorbed by the light absorbing material.

In further another aspect of the present disclosure, the light absorbing material may be disposed on a surface of the cavity of the diffusing body. In other words, the light absorbing material can be formed into a thin film on the surface of the cavity of the diffusing body. Herein, the surface of the cavity of the diffusing body is a light incident surface of the diffusing body. Hence, before the light emitting from the light emitting diode incidents into the diffusing body, the unwanted light in the yellow wavelength range which achieves the light incident surface can be absorbed by the light absorbing material first and then penetrate through the diffusing body and emit from the light emitting surface.

In addition, the present disclosure further provides a backlight module, comprising: a reflector; an optical film disposed on the reflector; and the aforesaid LED device disposed between the reflector and the optical film. Moreover, the present disclosure further provides a display device, comprising: the aforesaid backlight module; and a display panel disposed on the backlight module.

In the present disclosure, the backlight module can be a direct type backlight module.

In the present disclosure, the display panel can be a display panel which requires being equipped with the backlight module. For example, the display panel can be a liquid crystal display panel.

In the backlight module and display device of the present disclosure, the color gamut of the backlight module can be improved by using the aforesaid LED device. Even though phosphor powders are used in the light emitting layer of the LED in the LED device of the present disclosure, the backlight effect of the backlight module of the present disclosure is similar to that using quantum dots in the light emitting layer of the LED.

Other novel features of the disclosure will become more apparent from the following detailed description when taken in conjunction with the accompanying drawings.

### BRIEF DESCRIPTION OF THE DRAWINGS

FIG. 1A to FIG. 1C are cross-sectional view showing a process for manufacturing a LED according to Embodiment 1 of the present disclosure.

FIG. 2 is a cross-sectional view of a LED device according to Embodiment 1 of the present disclosure.

FIG. 3 is a cross-sectional view of a LED device according to Embodiment 2 of the present disclosure.

FIG. 4 is a cross-sectional view of a LED device according to Embodiment 3 of the present disclosure.

FIG. 5 is a cross-sectional view of a direct type backlight module according to Embodiment 4 of the present disclosure.

FIG. 6 is a cross-sectional view of a display device according to Embodiment 5 of the present disclosure.

FIG. 7A and FIG. 7B are diagrams showing test results of a comparative example and an experimental example in Test example of the present disclosure.

### DETAILED DESCRIPTION OF EMBODIMENT

The following embodiments when read with the accompanying drawings are made to clearly exhibit the above-mentioned and other technical contents, features and/or effects of the present disclosure. Through the exposition by means of the specific embodiments, people would further understand the technical means and effects the present disclosure adopts to achieve the above-indicated objectives. Moreover, as the contents disclosed herein should be readily understood and can be implemented by a person skilled in the art, all equivalent changes or modifications which do not depart from the concept of the present disclosure should be encompassed by the appended claims.

Furthermore, the ordinals recited in the specification and the claims such as “first”, “second” and so on are intended only to describe the elements claimed and imply or represent neither that the claimed elements have any proceeding ordinals, nor that sequence between one claimed element and another claimed element or between steps of a manufacturing method. The use of these ordinals is merely to differentiate one claimed element having a certain designation from another claimed element having the same designation.

Furthermore, the terms recited in the specification and the claims such as “above”, “over”, or “on” are intended not only directly contact with the other element, but also intended indirectly contact with the other element. Similarly, the terms recited in the specification and the claims such as “below”, or “under” are intended not only directly contact with the other element but also intended indirectly contact with the other element.

Furthermore, the terms recited in the specification and the claims such as “connect” is intended not only directly connect with other element, but also intended indirectly connect and electrically connect with other element.

In addition, the features in different embodiments of the present disclosure can be mixed to form another embodiment.

### Embodiment 1

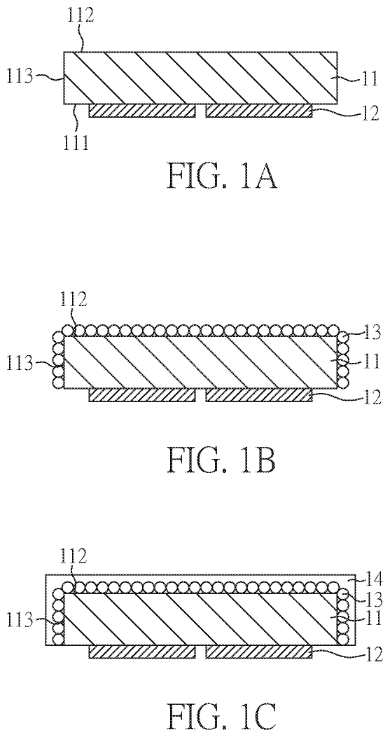

FIG. 1A to FIG. 1C are cross-sectional view showing a process for manufacturing a white LED according to the present embodiment.

As shown in FIG. 1A, a LED chip 11 is firstly provided, which has a first surface 111 and a second surface 112 opposite to the first surface 111; and two electrodes 12 (respectively an anode and a cathode) are disposed on the first surface 111 of the LED chip 11. In addition, the LED chip 11 further comprises a side surface 113 connecting to the first surface 111 and the second surface 112. The LED chip can be a blue light chip with an epitaxial layer grown thereon, a face-up chip, a vertical chip or a flip chip. In the present embodiment, the LED chip 11 is a blue light flip chip. More specifically, the LED chip 11 is a blue light flip chip with an epitaxial layer grown thereon.

As shown in FIG. 1B, a phosphor layer 13 is formed on the second surface 112 and the side surface 113 of the LED chip 11.

Herein, the phosphor layer 13 is a layer formed by plural phosphor powders. The types of the phosphor layer 13 is not particularly limited, and can be selected according to the type of the LED chip 11 or the desired color of the light emitting from the phosphor powders. For example, the phosphor powders capable of emitting yellow light after excitation can be used as the phosphor powders in the phosphor layer 13; and in this case, when the phosphor layer 13 is used together with the blue light LED chip, the LED can emit white light.

As shown in FIG a protection layer 14 is formed on the phosphor layer 13. In the present embodiment, the protection layer 14 can be an optical protection layer. In addition, the method for forming the protection layer 14 is not particularly limited, and the protection layer 14 can be formed by any coating process known in the art, such as a spin coating process, a blade coating process, an inject process, a printing process, a roll coating process or a spray coating process.

After the aforesaid process, a LED of the present embodiment can be obtained, which is a white LED. As shown in FIG. 1C, the LED of the present embodiment comprises: a LED chip 11 having a first surface 111 and a second surface 112 opposite to the first surface 111; two electrodes 12 disposed on the first surface 111 of the LED chip 11; and a phosphor layer 13 disposed on the second surface 112 of the LED chip 11.

In the present embodiment, the LED chip further comprises a side surface 113 connecting to the first surface 111 and the second surface 112, and the phosphor layer 13 is further disposed on the side surface 113. More specifically, in the present embodiment, the phosphor layer 13 is disposed on all the surfaces (including the second surface 112 and the side surface 113) of the LED chip 11 except for the first surface 111.

In the present embodiment, the LED further comprises a protection layer 14, wherein the protection layer 14 is disposed on the surfaces of the phosphor layer 13 corresponding to the second surface 112 and the side surface 113. More specifically, in the present embodiment, the phosphor layer 13 is disposed on the second surface 112 and the side surface 113 of the LED chip 11, and the protection layer 14 is used to protect the phosphor layer 13. Thus, the protection layer 14 is formed on the surfaces of the phosphor layer 13 corresponding to the second surface 112 and the side surface 113.

After completing the manufacture of the LED as shown in FIG. 1A to FIG. 1C, the LED shown in FIG. 1C can be disposed in a diffusing lens to obtain the LED device of the present embodiment.

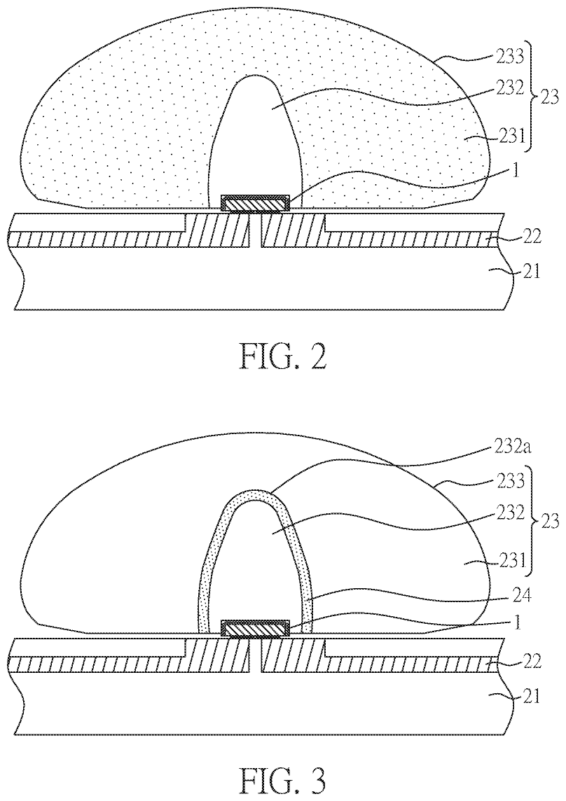

FIG. 2 is a cross-sectional view of a LED device according to the present embodiment. As shown in FIG. 2, the LED device of the present embodiment comprises: a diffusing lens 23 comprising a diffusing body 231, wherein the diffusing body 231 has a cavity 232 and a light emitting surface 233; a LED 1 (which is the LED shown in FIG. 1C) disposed in the cavity 232; and a light absorbing material disposed on a light path that light emitting from the LED 1 passes through the diffusing body 231 and emits from the light emitting surface 233, wherein the light absorbing material is a yellow light absorbing material.

As shown in FIG. 1C, the blue light emitting from the LED chip 11 can be mixed with the yellow light emitting from the phosphor powders of the phosphor layer 13 to obtain white light, and a light absorbing material is used in the LED of the present embodiment to absorb the unwanted light in the yellow wavelength range to further improve the color gamut of the white LED.

In the present embodiment, as shown in FIG. 2, the diffusing body 231 comprises the lens material and the light absorbing material. In other words, in the present embodiment, the diffusing body 231 is formed via a molding process by using a combination of the lens material and the light absorbing material. The molding process can be, for example, an injection molding process; but the present disclosure is not limited thereto. Hence, when the light emitting from the LED 1 penetrates through the diffusing body 231 and achieves the light emitting surface 233, the light absorbing material comprised in the diffusing body 231 can absorb the unwanted light in the yellow wavelength range to further improve the color gamut of the LED device.

In the present embodiment, the lens material may comprise PVC, PC, PMMA or a combination thereof, but the present disclosure is not limited thereto. Any material with high transmittance without influencing the light emitting from the LED chip can be used as the lens material of the present disclosure. In addition, in the present embodiment, the light absorbing material is a yellow light absorbing material capable of absorbing light having a wavelength in a range from 550 nm to 610 nm. Examples of the yellow light absorbing material capable of absorbing light having the wavelength in the range from 550 nm to 610 nm may comprise, but are not limited to a triphenylmethane-based material, cobalt blue, cobalt violet or a combination thereof.

Thus, as shown in FIG. 2, in the LED device of the present embodiment, the lens material is combined with the light absorbing material to prepare the diffusing lens 23, the redundant yellow unwanted light in the white light emitting from the diffusing lens 23 can be absorbed by the light absorbing material, so the intensity of the yellow unwanted light emitting from the light emitting surface 233 can be decreased to further improve the color gamut of the LED device.

In addition, as shown in FIG. 2, the LED device of the present embodiment can be disposed on a print circuit board 21, and a circuit 22 is disposed on the print circuit board 21. In addition, the electrodes 12 (as shown in FIG. 1C) of the LED 1 is electrically connected to the circuit 22.

### Embodiment 2

FIG. 3 is a cross-sectional view of a LED device according to the present embodiment. The LED device of the present embodiment is similar to that of Embodiment 1, except for the following differences.

In the present embodiment, as shown in FIG. 3, the diffusing body 231 of the diffusing lens 23 comprises the lens material, but does not comprise the light absorbing material.

In addition, in the present embodiment, the light absorbing material 24 is disposed on a surface 232a of the cavity 232. In other word, in the present embodiment, the light absorbing material 24 is formed into a thin film on the surface 232a of the cavity 232, and the surface 232a of the cavity 232 is the incident surface of the diffusing body 231. Herein, the method for preparing the thin film of the light absorbing material 24 is not particularly limited, and can be prepared by any coating process known in the art, such as a spin coating process, a blade coating process, an inject process, a printing process, a roll coating process or a spray coating process.

Hence, as shown in FIG. 3, in the LED device of the present embodiment, before the light emitting from the LED 1 incidents into the diffusing body 231, the unwanted light in the yellow wavelength range which achieves the surface 232a of the cavity 232 can be absorbed by the light absorbing material 24 first, so the intensity of the yellow unwanted light emitting from the light emitting surface 233 can be decreased to further improve the color gamut of the LED device.

### Embodiment 3

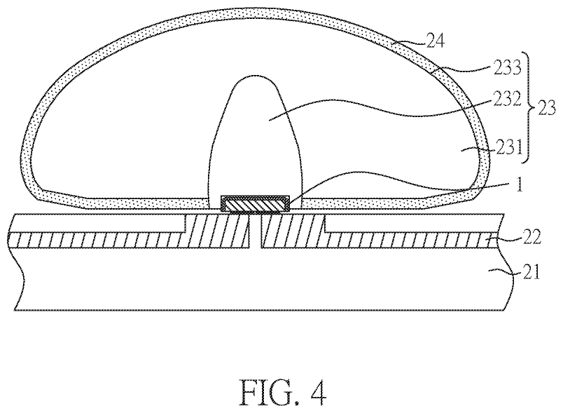

FIG. 4 is a cross-sectional view of a LED device according to the present embodiment. The LED device of the present embodiment is similar to that of Embodiment 2, except for the following differences.

In the present embodiment, the light absorbing material 24 is formed on the light emitting surface 233 of the diffusing body 231. In other words, in the present embodiment, the light absorbing material 24 is formed into a thin film on the light emitting surface 233 of the diffusing body 231.

Thus, as shown in FIG. 4, in the LED device of the present embodiment, when the light emitting from the LED 1 penetrates through the diffusing body 231 to achieve the light emitting surface 233, the unwanted light in the yellow wavelength range can be absorbed by the light absorbing material 24, so the intensity of the yellow unwanted light emitting from the light emitting surface 233 can be decreased to further improve the color gamut of the LED device.

In the aforesaid embodiments of the present disclosure, the light emitting surface 233 of the diffusing lens 23 has a curved shape; but the present disclosure is not limited thereto. In other embodiments of the present disclosure, the diffusing lens 23 may have other shapes as long as the purpose of light diffusing can be achieved.

Similarly, in the aforesaid embodiments of the present disclosure, the cavity 232 of the diffusing lens 23 also has a curved shape; but the present disclosure is not limited thereto. In other embodiments of the present disclosure, the cavity 232 may have other shapes as long as the purpose of light diffusing can be achieved.

In addition, in the aforesaid embodiments of the present disclosure, one LED 1 is disposed in the cavity 232; but the present disclosure is not limited thereto. In other embodiments of the present disclosure, plural LEDs 1 may be disposed in the cavity 232.

Furthermore, the structure of the LED suitable for the present disclosure is not limited to the structure of the LED described above, and can be adjusted according to the need. For example, in other embodiments of the present disclosure, the LED can be an LED bead formed with phosphor gel.

### Embodiment 4

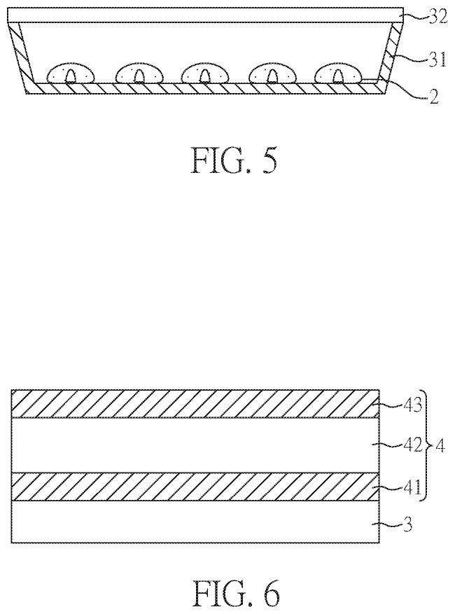

FIG. 5 is a cross-sectional view of a direct type backlight module according to the present embodiment. As shown in FIG. 5, the backlight module of the present embodiment comprises: a reflector 31; an optical film 32 disposed on the reflector 31; and an LED device 2 disposed between the reflector 31 and the optical film 32. An the present embodiment, the LED device 2 can be any one of the LED devices of Embodiment 1 to Embodiment 3.

In the present embodiment, the reflector 31 can also be used as a back plate for the backlight module. In addition, even not shown in the figure, the optical film 32 may comprise any film usually used in the backlight module, for example, a diffusing film, a prism film or a brightness enhancement film. However, the present disclosure is not limited thereto, and the component of the optical film 32 can be adjusted according to the need.

### Embodiment 5

FIG. 6 is a cross-sectional view of a display device according to the present embodiment. As shown in FIG. 6, the display device of the present embodiment comprises: a backlight module 3; and a display panel 4 disposed on the backlight module 3. The backlight module 3 can be the backlight module shown in Embodiment 4. In addition, the display panel 4 may comprise: a first substrate 41; a second substrate 43 opposite to the first substrate 41; and a display medium layer 42 disposed between the first substrate 41 and the second substrate 43. In the present embodiment, the display medium layer 42 may be a liquid crystal layer.

In one aspect of the present embodiment, the first substrate 41 can be a transistor substrate with transistors (not shown in the figure) disposed thereon, and the second substrate 43 can be a color filter substrate with a color filter layer (not shown in the figure) and a black matrix layer (not shown in the figure) formed thereon. In another aspect of the present embodiment, the color filter layer (not shown in the figure) may be disposed on the first substrate 41, and the first substrate 41 in this case can be a color filter on array (COA) substrate. In further another aspect of the present embodiment, the black matrix layer (not shown in the figure) may be disposed on the first substrate 41, and the first substrate 41 in this case can be a black matrix on array (BOA) substrate.

### Test Example

In the present text example, the LED device of Embodiment 2 (as shown in FIG. 3) is used in the experimental example, wherein the phosphors in the phosphor layer 13 (as shown in FIG. 1C) of the LED 1 comprises red phosphors (potassium fluoride silicon, KSF) and green phosphors beta-Sialon:Eu²⁺ nitroxide) in a weight ratio of 2:1, and the material of the protection layer 14 (as shown in FIG. 1C) is an optical protection gel. In addition, the material of the diffusing body 231 is PVC, and the light absorbing material 24 is triphenylmethane dyes. The experimental condition for the comparative example is similar to that for the experimental example, except that the diffusing lens 23 does not comprise the light absorbing material in the comparative example. Herein, the spectra obtained from the comparative example and the experimental example are respectively detected by an LED integrating sphere, and the color gamut obtained in the comparative example and the experimental example is detected by a color analyzer.

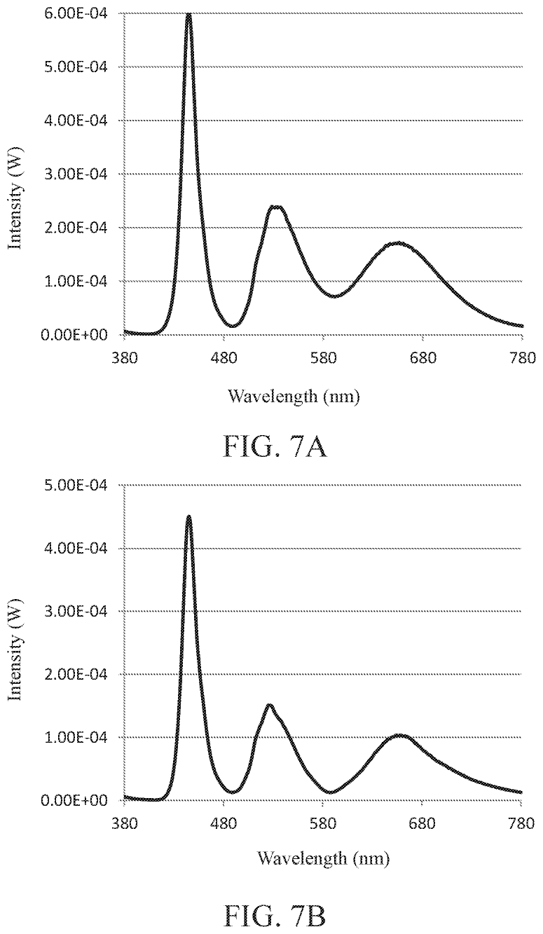

The spectra obtained in the comparative example and the experimental example are respectively shown in FIG. 7A and FIG. 7B. As shown in FIG. 7A, when the diffusing lens 23 does not comprise the light absorbing material which means that the surface of the cavity is not formed with the yellow light absorbing material, the color gamut of the National Television Standards Committee (NTSC) is about 88%. As shown in FIG. 7B, when the diffusing lens 23 comprises the light absorbing material which means that the surface of the cavity is coated with the yellow light absorbing material, the color gamut of NTSC can be increased to 96%. These results indicate that when the diffusing lens 23 comprises light absorbing material, the unwanted light in the yellow wavelength range can be effectively reduced, and thus the color gamut of the LED device can further be improved.

The LED device of the present disclosure can be used as a light source for the backlight module of any display device. Examples of the display device may comprise, but are not limited to, displays, mobile phones, laptops, video cameras, still cameras, music players, mobile navigators, TV sets, etc.

Although the present disclosure has been explained in relation to its embodiment, it is to be understood that many other possible modifications and variations can be made without departing from the spirit and scope of the disclosure as hereinafter claimed.

What is claimed is:

1. A light emitting diode (LED) device, comprising:
a diffusing lens comprising a diffusing body, wherein the diffusing body has a cavity and a light emitting surface;
a light emitting diode disposed in the cavity; and
a light absorbing material disposed on a light path that light emitting from the light emitting diode passes through the diffusing body and emits from the light emitting surface, wherein the light absorbing material is a yellow light absorbing material.

2. The LED device of claim 1, wherein the yellow light absorbing material absorbs light having a wavelength in a range from 550 nm to 610 nm.

3. The LED device of claim 1, wherein the yellow light absorbing material is a triphenylmethane-based material, cobalt blue, cobalt violet or a combination thereof.

4. The LED device of claim 1, wherein the diffusing body comprises a lens material and the light absorbing material.

5. The LED device of claim 1, wherein the light absorbing material is disposed on the light emitting surface of the diffusing body.

6. The LED device of claim 1, wherein the light absorbing material is disposed on a surface of the cavity of the diffusing body.

7. A backlight module, comprising:
a reflector;
an optical film disposed on the reflector; and
an LED device disposed between the reflector and the optical film and comprising:
a diffusing lens comprising a diffusing body, wherein the diffusing body has a cavity and a light emitting surface;
a light emitting diode disposed in the cavity; and
a light absorbing material disposed on a light path that light emitting from the light emitting diode passes through the diffusing body and emits from the light emitting surface, wherein the light absorbing material is a yellow light absorbing material.

8. The backlight module of claim 7, wherein the yellow light absorbing material absorbs light having a wavelength in a range from 550 nm to 610 nm.

9. The backlight module of claim 7, wherein the yellow light absorbing material is a triphenylmethane-based material, cobalt blue, cobalt violet or a combination thereof.

10. The backlight module of claim 7, wherein the diffusing body comprises a lens material and the light absorbing material.

11. The backlight module of claim 7, wherein the light absorbing material is disposed on the light emitting surface of the diffusing body.

12. The backlight module of claim 7, wherein the light absorbing material is disposed on a surface of the cavity of the diffusing body.

13. A display device, comprising:
a backlight module; and
a display panel disposed on the backlight module;
wherein the backlight module comprises: a reflector; an optical film disposed on the reflector; and an LED device disposed between the reflector and the optical film and comprising:
a diffusing lens comprising a diffusing body, wherein the diffusing body has a cavity and a light emitting surface;
a light emitting diode disposed in the cavity; and
a light absorbing material disposed on a light path that light emitting from the light emitting diode passes through the diffusing body and emits from the light emitting surface, wherein the light absorbing material is a yellow light absorbing material.

14. The display device of claim 13, wherein the yellow light absorbing material absorbs light having a wavelength in a range from 550 nm to 610 nm.

15. The display device of claim 13, wherein the yellow light absorbing material is a triphenylmethane-based material, cobalt blue, cobalt violet or a combination thereof.

16. The display device of claim 13, wherein the diffusing body comprises a lens material and the light absorbing material.

17. The display device of claim 13, wherein the light absorbing material is disposed on the light emitting surface of the diffusing body.

18. The display device of claim 13, wherein the light absorbing material is disposed on a surface of the cavity of the diffusing body.
